(19) United States
(12) Patent Application Publication
(10) Pub. No.: US 2006/0192305 A1
(43) Pub. Date: Aug. 31, 2006

(54) Drain plate for cooling towers

(76) Inventor: Bo-Han Sung, Taichung City (TW)

Correspondence Address: CHARLES E. BAXLEY, ESQ., 90 JOHN STREET, THIRD FLOOR, NEW YORK, NY, 10038, US

(21) Appl. No.: 11/067,989

(22) Filed: Feb. 28, 2005

(51) Int. Cl. B01F 3/04

(52) U.S. Cl. 261/111; 261/DIG. 11

(57) ABSTRACT

A drain plate for cooling towers includes a plurality of parallel first ribs and second ribs extending from the plate and the first ribs are perpendicular to the second ribs. First passages and second passages are respectively defined between the first ribs and the second ribs. The first and second ribs each include notches. A peripheral wall extends from a periphery of the plate and a plurality of notches are defined in a top edge of the peripheral wall so that water over flows the first and second ribs and flows out from the notches in the peripheral wall so that cool water evenly spreads on the hot water pipes.

### FIELD OF THE INVENTION

The present invention relates to a drain plate for cooling towers and the drain plate includes parallel multiple longitudinal and altitude ribs to form passages and notches are defined in the peripheral wall of the plate so that water evenly drains from the notches.

### BACKGROUND OF THE INVENTION

A conventional cooling tower generally includes at least one enclosed tube and a plurality of outlets are arranged above or beneath the at least one tube. The outlets are located at equal distance so that the cool water flows out from the outlets to cool the hot water pipe. However, if the inner calibers of the outlets are too big, the cool water stream flows out from the outlet at a certain speed so that there will be no cool water right beneath the outlets. This means that the cool water is not evenly spread on the hot water pipe and the cooling efficiency becomes less. If the inner diameters of the outlets are too small, foreign objects could stock the outlets and the cool water becomes water mist which is so light and blown away by the fan. In other words, a certain quantity of cool water is useless. The pressure at the outlets is increased because the small calibers of the outlets and the increased pressure increases the load of the motor.

The present invention intends to provide a drain plate that includes multiple longitudinal and altitude ribs so as to form passages in two directions and a plurality of notches are defined in the peripheral wall of the plate such that water flows out from the notches and evenly spreads on the hot water pipe.

### SUMMARY OF THE INVENTION

The present invention relates to a drain plate for cooling towers and the drain plate comprises a peripheral wall extending from a periphery of the plate and a plurality of first notches defined in a top edge of the peripheral wall. A plurality of parallel ribs extending from the plate and first passages are defined between the first ribs. The first ribs include second notches such that cool water over flows the second notches and flows out from the first notches.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a drain plate of the present invention;

FIG. 2 shows that two drain plates are overlapped;

FIG. 3 is a cross sectional view to show the overlapped drain plates are installed in a cooing tower;

FIG. 4 is another cross sectional view to show the overlapped drain plates are installed in a cooing tower;

FIG. 5 shows another embodiment of the drain plate, and

FIG. 6 shows a supply pipe connected to the peripheral wall of the drain plate.

### DETAILED DESCRIPTION OF THE PREFERRED EMBODIMENT

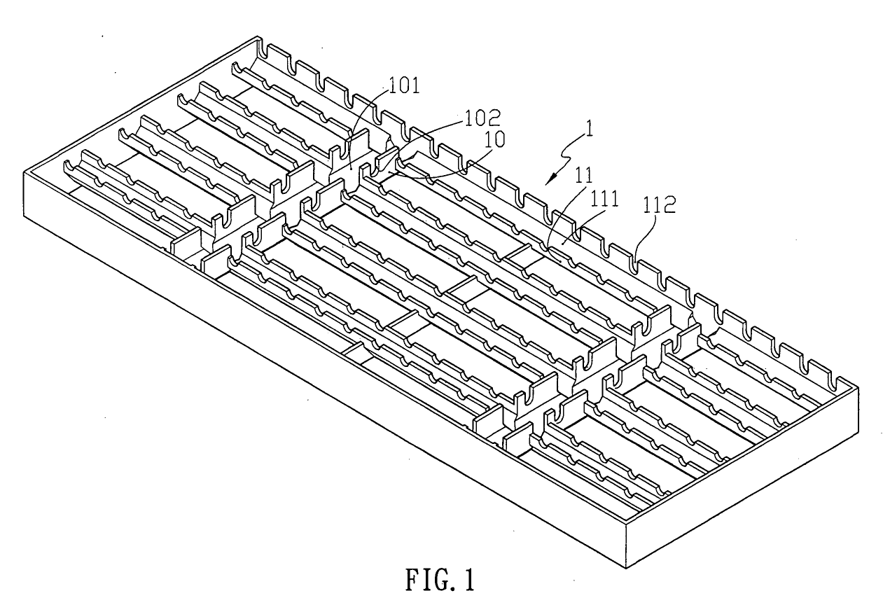

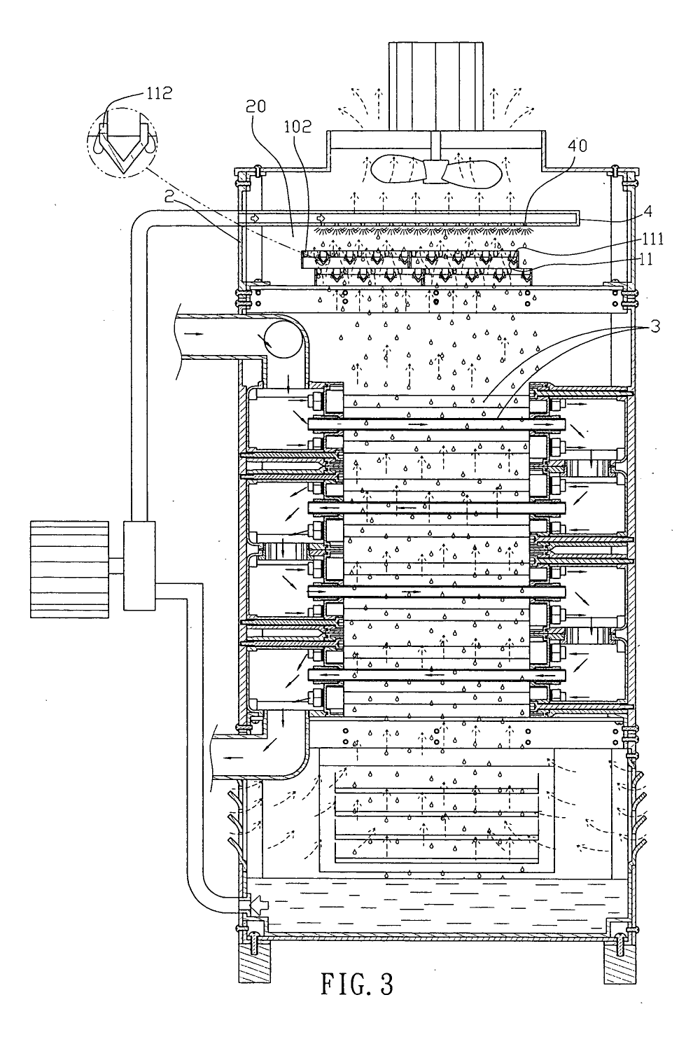

Referring to FIG. 1, the drain plate 1 of the present invention used in a cooling tower 2 as shown in FIG. 3 comprises a peripheral wall extending from a periphery of the plate 1. A plurality of first notches 112 are defined in a top edge of the peripheral wall. A plurality of parallel first ribs 10 and a plurality of parallel second ribs 11 extend from the plate 1. The first ribs 10 are perpendicular to the second ribs 11. First passages 101 are defined between the first ribs 10 and second passages 101 are defined between the second ribs 11. The first ribs 10 include second notches 102 and the second ribs 11 include third notches 111. The peripheral wall is higher than that of the first ribs 10 and the second ribs 11.

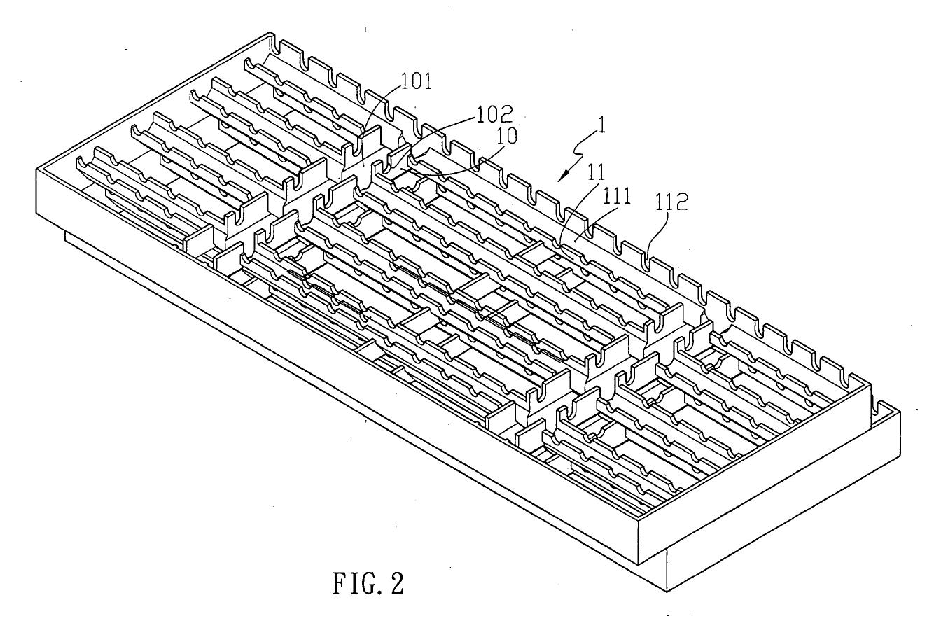

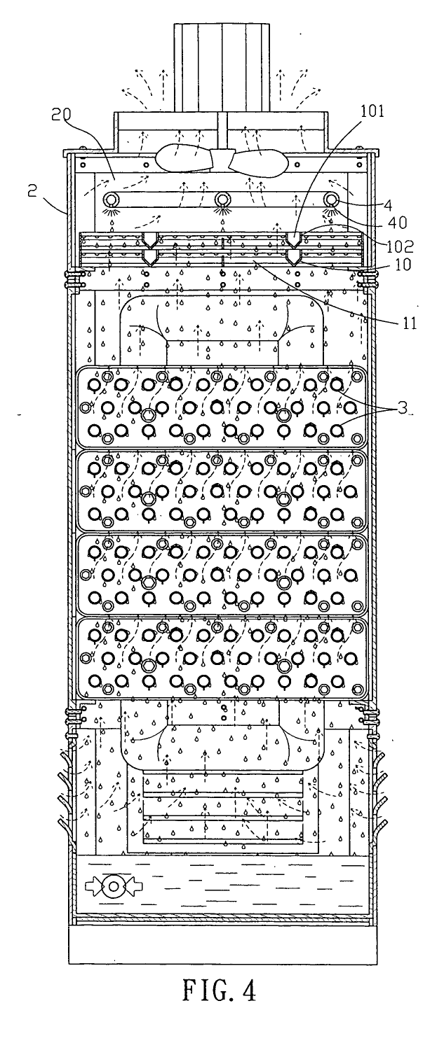

As shown in FIG. 2, two drain plates 1 can be overlapped with each other and the first ribs 10 of the two drain plates 1 are located alternatively with each other, and the second ribs 11 of the two drain plates 1 are located alternatively with each other. As shown in FIGS. 3 and 4, the overlapped drain plates 1 are installed in a space 20 in the cooling tower 2 and located between the hot water pipes 3 and tube 4 such that water in the tube 4 flows out from t he openings 40 of the tube 4 and directly drops into the two overlapped drain plates 1. The water is collected in the drain plates 1 and when the water level is higher than the second notches 102 and the third notches 111, the water enters the next passages 101, 111. The water flows out from the first notches 112 when the water level raises and drops on the hot water pipes 3. By this way, the cool water is spread on the hot water pipes 3 evenly.

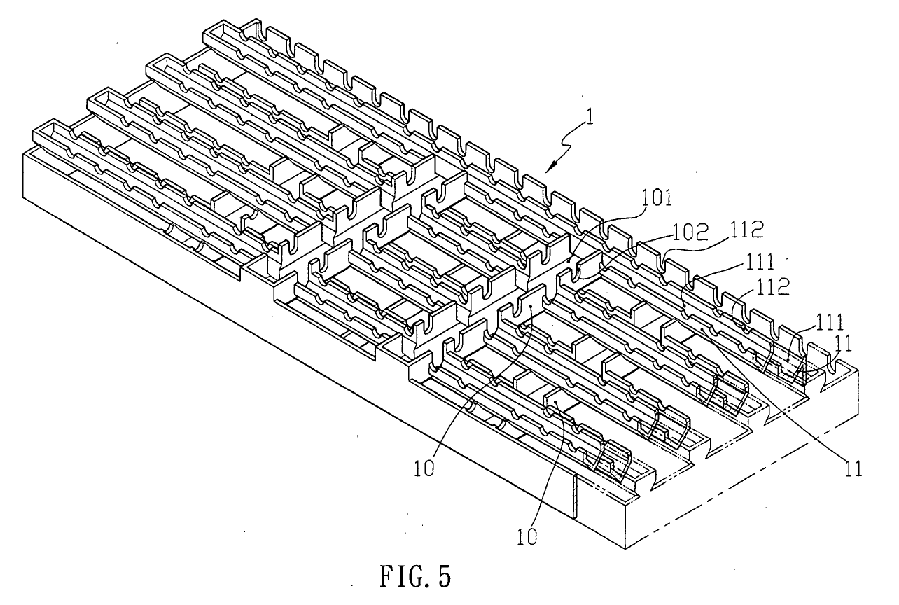

As shown in FIG. 5, the drain plate 1 can also be made to let the first ribs 10 and the second ribs 11 be located at two different horizontal planes.

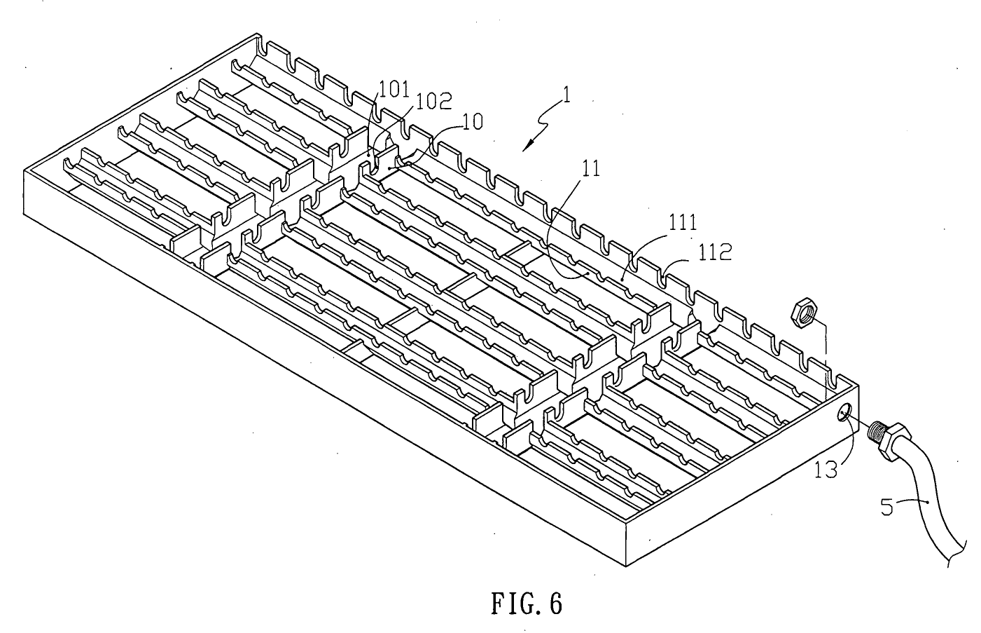

FIG. 6 shows that a connection hole 13 is defined through the peripheral wall and a supply pipe 5 is engaged with the connection hole 13. By the supply pipe 5, cool water is supplied into the drain plate 1 via the supply pipe 5.

While we have shown and described the embodiment in accordance with the present invention, it should be clear to those skilled in the art that further embodiments may be made without departing from the scope of the present invention.

1. A drain plate for cooling towers, comprising:
a peripheral wall extending from a periphery of the plate, a plurality of first notches defined in a top edge of the peripheral wall, a plurality of parallel first ribs extending from the plate and first passages defined between the first ribs, the first ribs including second notches.

2. The drain plate as claimed in claim 1, wherein the peripheral wall is higher than that of the first ribs.

3. (canceled)

4. The drain plate as claimed in claim 1, wherein the peripheral wall is higher than that of the second ribs.

5. The drain plate as claimed in claim 1, wherein the first and second ribs are located at different planes.

6. The drain plate as claimed in claim 1, wherein a connection hole is defined through the peripheral wall and a supply pipe is engaged with the connection hole.
